(19) United States
(12) Patent Application Publication
(10) Pub. No.: US 2014/0311419 A1
(43) Pub. Date: Oct. 23, 2014

(54) COMESTIBLE PLAY TREAT FOR COMPANION ANIMALS

(71) Applicant: NESTEC SA, Vevey (CH)

(72) Inventors: Dan Kenneth Dixon, St. Louis, MO (US); Sandra Lyn, St. Louis, MO (US); Michael E. Leiweke, Hillsboro, MO (US)

(73) Assignee: NESTEC SA, Vevey (CH)

(21) Appl. No.: 14/254,258

(22) Filed: Apr. 16, 2014

Related U.S. Application Data
(60) Provisional application No. 61/813,308, filed on Apr. 18, 2013.

(51) Int. Cl. A01K 15/02

(52) U.S. Cl. CPC A01K 15/025
USPC 119/707

(57) ABSTRACT

The disclosure provides comestible play treats that are adapted for contact-responsive, play-inducing movement. The shape of the treats makes them wobbly and prone to rocking, partially rolling and/or spinning when contacted by an animal. Also provided herein are methods of using the comestible play treats to induce play, increase the health and well-being of an animal, maintain ideal body weight, or improve the quality of life of an animal.

### CROSS REFERENCE TO RELATED APPLICATIONS

This application claims priority to U.S. Provisional Application No. 61/813,308 filed Apr. 18, 2013, the disclosure of which is incorporated herein by this reference.

### BACKGROUND OF THE INVENTION

1. Field of the Invention

This invention relates generally to play toys and comestible treats and particularly to comestible play treats for companion animals.

2. Description of Related Art

Companion animals need enriching experiences such as play to improve their physical and mental health and well-being. Young companion animals naturally tend to play extensively. Felines in particular have a playful nature and often enjoy batting and chasing various objects, such as play toys, even into their senior years.

Currently available foods and treats for companion animals are intended for consumption by the animal. Currently available toys for companion animals are intended to provide enriching activity for the animals by occupying and entertaining the animal, particularly for relatively extended periods. Some toys are intended to be chewed by an animal, particularly dogs, to maintain oral health such as gums and teeth, or to freshen the breath.

In addition, toys can help provide physical activity for the animal. Play activities in companion animals can stimulate the animal's appetite. There is, therefore, an ongoing need for new types of comestible treats, as well as toys to encourage playfulness.

### SUMMARY OF THE INVENTION

It is, therefore, an object of the invention to provide a comestible play treat for companions.

It is another object of the invention to provide comestible play treats that also function as both a toy and a treat by encouraging playfulness before and during consumption. The toy-like aspects include the tendency of the play treat to move (e.g., wobble, rock, spin and/or partially roll) in response to contact from the animal, including incidental contact.

It is another object of the invention to provide methods for inducing play and/or promoting the health and wellness of animals, particularly felines.

It is a further object of the invention to provide methods for managing the weight of animals, or maintaining an ideal weight by encouraging play activities.

One or more of these other objects are achieved using a comestible play treat for animals comprising a comestible composition that has at least a partially arcuate shape that induces the animals, particularly felines, to play with the treats before and during consumption.

Other and further objects, features, and advantages of the present invention will be readily apparent to those skilled in the art.

### BRIEF DESCRIPTION OF THE DRAWINGS

FIG. 1 is a photograph of an embodiment of pet treat as described in Example 1. The embodiment of the treat depicted did not induce an animal to play with it in the studies described in the Examples. The overall shape of the treat appears to lack a natural tendency to respond to contact with play-inducing motion, such as wobbling, rocking, spinning, or partially rolling.

FIGS. 2-7 shows various embodiments of the comestible play treat disclosed herein.

FIG. 2 shows an embodiment of the comestible play treat as described in Example 2. It is similar to the treat in Example 1 in certain aspects, however the length of the play treat is approximately 6-8 times longer than the treat disclosed in Example 1, and accordingly is more contact-responsive. While the treats depicted in both of FIGS. 1 and 2 were extruded through the same crescent-shaped die, it is noted the long axis of the treat in FIG. 1 corresponds to the short axis of the play treat depicted in FIG. 2.

FIG. 3 depicts another embodiment of a play treat (as described in Example 3). The play treat was extruded through a die with an asymmetric taper and wider taper angle than for dies of Example 1. As can be seen, the resultant play treat was found to be contact-responsive. Additionally, relative to the embodiment of the play treat shown in FIG. 2, this embodiment also showed an increased tendency to remain ‘upright’, i.e., to return to its play-inducing contact-responsive concave hull rather than to lie on its side.

FIG. 4 shows another embodiment of a play treat (as described in Example 4). The play treat depicted was extruded through a die with a wider taper angle than the dies of Example 1.

FIG. 5 shows another embodiment of a play treat (as described in Example 5). The play treat in this embodiment was made with the same die as the play treats shown in FIG. 4, except that the die was rotated 180 degrees with respect to the cutter, thus resulting in a different final shape and dimensions of the play treat.

FIG. 6 shows another embodiment of a play treat (as described in Example 6). This embodiment feature a play treat with two different layers that are co-extruded as inner and outer layers, respectively.

FIG. 7 shows another embodiment of a play treat (as described in Example 7). The play treat depicted was extruded through an S-shaped e., sigmoidal) die.

### DETAILED DESCRIPTION OF THE INVENTION

### Definitions

As used herein a “comestible play treat” comprises attributes and aspects of both a toy and treat for an animal. With respect to the attributes of a toy, the comestible play treat disclosed herein are adapted to have contact-responsive, play-inducing movement. “Play inducing movement” generally comprises any movement that will entertain, surprise, attract the attention of, or otherwise engage an animal, including by touching the animal or moving away from the animal. Preferred play-inducing movements are rocking and spinning motions, and partial rolling. The shape of the comestible play treats is well-suited to allow for such movements, particular in response to contact from an animal, i.e., the contact-responsiveness of the play treat is inherent in the shape of the play treat. The shape is partially unstable (i.e., wobbly) and has a tendency to readily wobble, rock, roll, or spin rather than to remain at rest when contacted. Such contact may include any type of contact including, but not limited to, touching the play treat with a paw, with the animal's nose, licking the treat, or touching the treat with the nose (e.g., to push (“nose”) the treat or in the act of sniffing or smelling the treat). The animal may be surprised when the animal touches one end of the play treat and the other end moves toward or way from the animal. In some embodiments, an additional portion of the play treat may touch the animal e.g., when the animal licks or attempts to bite one end of the play treat, the other end may wobble, rock, roll, or reposition so that a different portion of the play treat touches the animal elsewhere.

The term “companion animal” means any domesticated animal such as cats, dogs, ferrets, birds, rabbits, guinea pigs, hamsters, mice, gerbils, pleasure horses, cows, goats, sheep, donkeys, pigs, and more exotic species kept by humans for company, psychological support, education, physical assistance, amusement, extrovert display, and all of the other functions that humans desire or need to share with animals of other species. Preferred species are those that enjoy playing with their food, such as cats, dogs, ferrets and the like.

As used herein, the term “food” or “food composition” means a composition that is intended for ingestion by an animal, including a human, and provides nutrition thereto. “Pet foods” are compositions intended for consumption by pets, particularly by companion animals.

The term “health and/or wellness of an animal” means the complete physical, mental, and social well being of the animal, not merely the absence of disease or infirmity.

The term “regular” as used herein with respect to the compositions or methods disclosed herein means providing the composition to, or carrying out the method with an animal on a repeated basis. The skilled artisan will appreciate that the frequency will be a function of the method or composition, i.e., the frequency useful or required to attain a desired biochemical, physiological, or other effect, or the like, including psychological effects. One goal of regular use or administration is to provide the animal with a regular and/or consistent benefits of the composition or the methods, including the direct and indirect benefits. Regular and/or consistent use will preferably increase the health and/or wellness of the animal or provide the direct or indirect benefits of the methods or compositions as compared to those of an animal not receiving the compositions or methods. “Regular basis” thus refers to at least weekly use or administration, once weekly, once daily. Administration can be more frequent than once daily, such as multiple times per day. Administration on other bases is also contemplated, such as every other day, every other week, every third day, every fourth day, or the like. Other frequencies, regardless of whether expressly exemplified herein, may be deemed useful for particular applications. The term “extended regular basis” as used herein refers to long term use or administration of a composition or method on a regular basis.

The term “about” means plus or minus about 20%, preferably plus or minus about 10%, more preferably plus or minus about 5%, most preferably plus or minus about 2%.

All percentages expressed herein are by weight of the total weight of the composition unless expressed otherwise.

As used herein, ranges are used for describing each and every value within the range. Any value within the range can be selected as the range.

The invention is not limited to the particular methodology, protocols, and reagents described herein because they may vary. Further, the terminology used herein is for the purpose of describing particular embodiments only and is not intended to limit the scope of the present invention.

As used herein, the singular form of a word includes the plural, and vice versa, unless the context clearly dictates otherwise. Thus, the references “a”, “an”, and “the” are generally inclusive of the plurals of the respective terms. For example, reference to “a treat” or “a method” includes a plurality of such “treats” or “methods.” Similarly, the words “comprise”, “comprises”, and “comprising” are to be interpreted inclusively rather than exclusively. Likewise the terms “include”, “including” and “or” should all be construed to be inclusive, unless such a construction is clearly prohibited from the context. Similarly, the term “examples,” particularly when followed by a listing of terms, is merely exemplary and illustrative and should not be deemed to be exclusive or comprehensive.

Unless defined otherwise, all technical and scientific terms and any acronyms used herein have the same meanings as commonly understood by one of ordinary skill in the art in the field of the invention. Although any compositions, methods, articles of manufacture, or other means or materials similar or equivalent to those described herein can be used in the practice of the present invention, the preferred compositions, methods, articles of manufacture, or other means or materials are described herein.

All patents, patent applications, publications, and other references cited or referred to herein are incorporated herein by reference to the extent allowed by law. The discussion of those references is intended merely to summarize the assertions made therein. No admission is made that any such patents, patent applications, publications or references, or any portion thereof, are relevant prior art for the present invention and the right to challenge the accuracy and pertinence of such patents, patent applications, publications, and other references is specifically reserved.

### Aspects of The Invention

The inventors have discovered that providing a comestible treat with certain shape attributes that make it unstable or wobbly on a surface, the treat induces play in an animal, such as a companion animal. These treats, referred to herein as ‘play treats’ have a tendency to wobble, rock, spin and the like in response to contact from an animal. When the play treats moves in response to contact by the animal, and surprisingly the animal generally becomes more playful as determined by a variety of criteria. Such treats not only give pleasure to the animal and caregiver but also increase activity levels and help manage weight and promote the health and wellness of the animal.

In a first of its several aspects, the invention provides comestible play treats for companion animals. The comestible play treats generally comprise a contact-responsive, play-inducing shape. The play treats comprise a body having an at least partially curved or arcuate shape. The shape provides at least one substantially concave outer surface portion on the body. This concave outer surface portion form an unstable or wobbly base, upon which the play treat may ‘rest’. However, as a result of the curved or radiused surfaces, the play treat is wobbly or unstable. By design, the play treat has unstable concave outer portion(s) (i.e., an unstable base) that provide(s) a tendency to readily move in response to contact by the animal, including efforts by the animal to lick, taste, or eat the play treat. The play treat may also move when presented to the animal—i.e., the play treat may wobble, rock, or spin, or even partially roll when placed on a surface just from the energy of so placing it. Thus when oriented on its ‘wobbly’ base (concave surface), the play treats are adapted for play-inducing motion in response to contact by a companion animal.

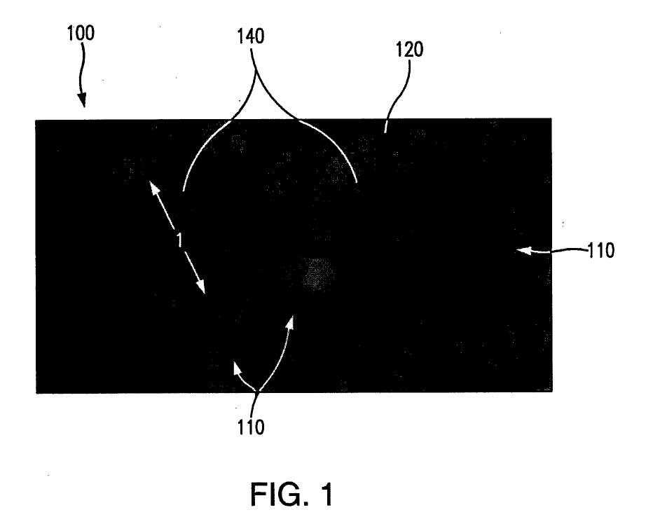

Certain features of the comestible play treat may be better understood by reference to the figures. With reference to FIG. 1, an embodiment 100 of extruded pet treats 110 can be seen. The embodiment comprises a plurality of extruded treats 110 approximately 0.25″ by 0.25″ (see Example 1). As can be observed, the treats 110 feature a substantially arcuate shape 120 along axis (1). However, as described in Example 8 (see Table 3) below, the treats were not play-inducing in the studies performed. It is believed that because the treat was primarily oriented on a relatively stable, substantially flat side 140, it was unable to respond to contact by the animal with any motion, and accordingly did not activate the animal's desire or instinct to play.

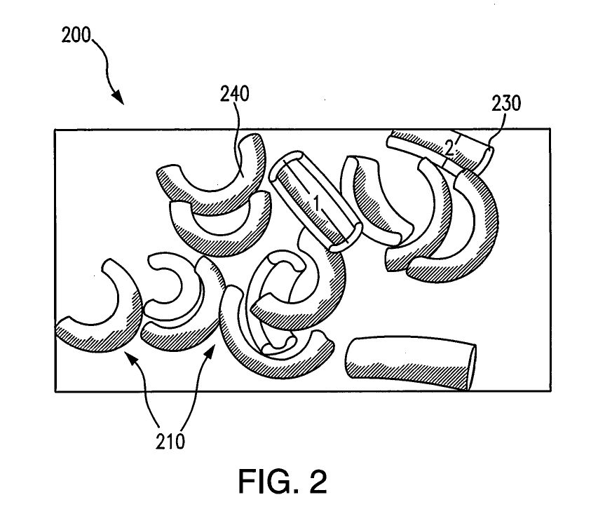

With reference to FIG. 2, an embodiment 200 of a play treat 210 is seen, with a plurality of such treats 210 shown. The extruded treats 210 in FIG. 2 were extruded using the same compositions and conditions, and the same extrusion die as those in FIG. 1. The only major difference between the treats is elongate body of play treats 210, which have a much greater length of the along the axis (1). As described in Example 2, these treats 210 were nearly 1.5-2″ long, as compared to 0.25″ in FIG. 1. The play treats in FIG. 2 have a crescentiform cross sectional profile. It is also evident that because of the added length, the radius 230 along the second axis (2) can be seen. However, the play treats 210 are fairly narrow along the short axis (2) and as a result the play treats can readily lie on the relatively flat side 240 and remain fairly stable. Accordingly, while these play treats were able to stimulate some play (see Table 3, Example 8), it was not as much as subsequent play treats that were better able to maintain orientation on a wobbly or unstable side or base.

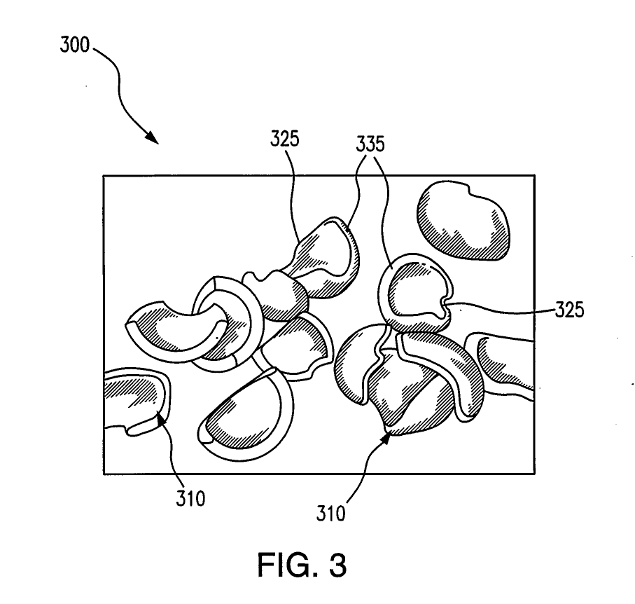

With further reference to the figures, FIG. 3 shows an embodiment 300 of a play treat 310. A plurality of such treats 310 are shown. The play treats 310 have a crescentiform cross-sectional profile; however, as can be seen they were extruded through an asymmetric tapered die and feature one side 325 that is shorter than the other side 335. It can be seen that the play treats 310 are better adapted to maintain the orientation on a wobbly or unstable portion (i.e., base). The play treats 310 have a relatively low center of gravity and only when flipped completely upside down will they lose their contact-responsiveness or ability to induce play. As a result, these play treats 310 were much better at inducing play when tested with multiple cats (see, e.g., Table 3, Example 8).

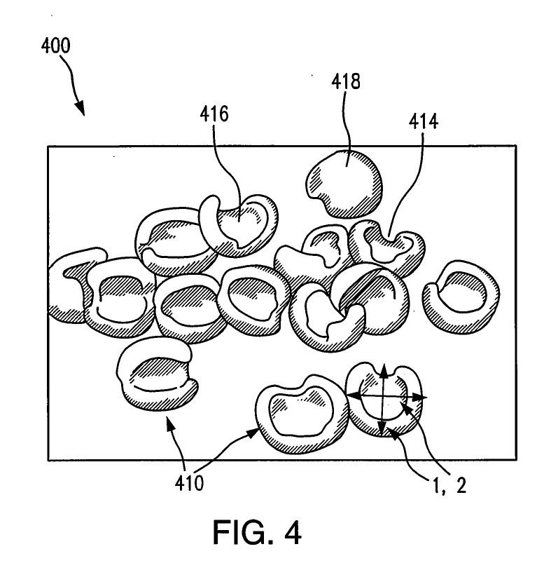

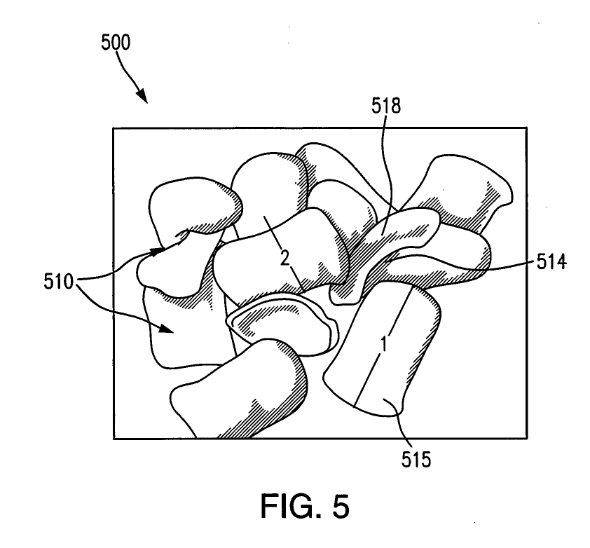

With respect to FIGS. 4 and 5, shown are two different embodiments (400 and 500, respectively) of play treats. The difference between them is that the extrusion die was rotated 180 degrees with respect to the rotary cutter. Play treats 410 are much shorter (0.75″) than those depicted in FIG. 5, and feature a crescent profile in cross section along two axes (1, 2) each about the same length. For this reason play treats 410 have a strong tendency to remain oriented on a wobbly concave outer surface 418 and therefor to remain contact-responsive with concomitant movements such as wobbling, rocking, and spinning. The results in Table 3 (Example 8) show that play treats 410 were the most successful in stimulating play from a group of cats on which they were tested under the stated conditions. The play treats 410 feature an inner convex surface 414 that provides probably the most well defined inner space 416 of all the embodiments depicted. The play treats 410 are fairly symmetrical compared to those in FIG. 5. The play treats 510 in FIG. 5 feature an elongate body 515 (along the axis 1) with a crescentiform cross-sectional profile and additional radius along axis 2. When the play treat is on it concave outer surface 512, it has the tendency to move in response to external contact, such as from an animal. Like play treats 410 above, the play treats 510 are generally configured to remain oriented on the wobbly concave surface 518 on which they can readily spin, rock, and wobble in response to contact. The results of Example 8 show that play treats 510 of this embodiment were also successful in inducing play in cats under the conditions tested.

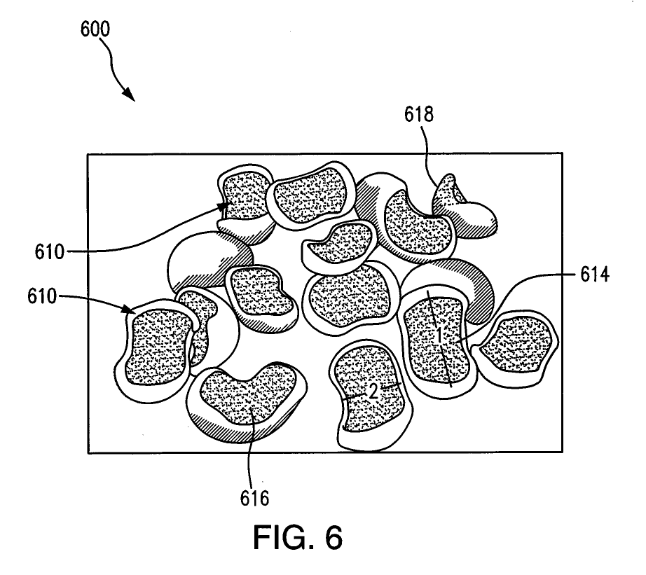

With further reference to the figures, FIG. 6 shows an embodiment 600 featuring dual layered play treats 610. The inner layer 614 comprises a different composition than the outer layer 618 and defines an interior space 616 of the play treats 610. The inner and outer layers (614, 618) were co-extruded to form the play treats 610 which have a crescent-shaped cross-section along both the major and minor axes (1,2). As seen in Example 8 (Table 4) the play treats 610 were also very useful for triggering play.

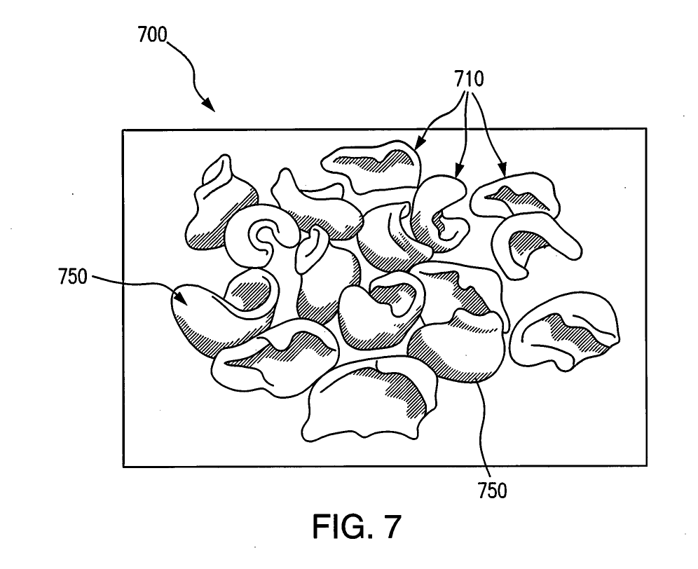

FIG. 7 depicts a further embodiment 700 of play treats 710. The play treats 710 feature a concave surface or hull 750 with multiple radii along multiple axes. The play treats 710 have multiple concave surface portions that provide the requisite instability or “wobbliness” that is contact-responsive and play-inducing.

Accordingly in various embodiments, the play treat feature a concave surface portion, a crescentiform cross section, a concave hull portion, and/or multiple radiused portions to provide the instability needed for contact-responsiveness and the ability to produce play-inducing or play-stimulating movement. In preferred embodiments, the play-inducing motion includes any type of wobbling, rocking, spinning, or partially rolling of the play treat, or even a combination thereof.

In one embodiment, the body of the comestible play treat comprises a plurality of radii oriented in two or more axes. In one embodiment, these radii form a hull area or a concave outer surface portion that may be regular or irregular.

Preferably the shape, weight, and center of gravity of the play treat are adapted to help maintain the orientation of the play treat on its concave surface portion(s) so as to facilitate play-inducing motion in response to contact by a companion animal.

As can be seen in the figures, if the body of the play treat is too narrow relative to the length of the body, the play treat will lie on its side, which may comprise a relatively flat area that is not conducive to contact-responsiveness. Thus, in some embodiments the body's width relative to its length helps maintain the orientation of the play treat on one or more of its concave surface portions.

In certain presently preferred embodiments, the body has a cross-sectional profile that is crescentiform along at least one axis. In other embodiments, the body may have a crescent cross sectional profile along two, three, or more axes.

As described above, the play treat is curved in one or more directions, and thus may feature one or a plurality of radii defining such curves. In various embodiments, the play treats may comprise 2, 3, 4, 5 or even more different radii. Moreover, it will be evident to the skilled artisan that curvature in any one direction may vary and may be described by multiple radii, each defining a portion of curvature.

It is to be understood that describing the curvature of surfaces such as those shown for the play treats exemplified herein and depicted in the Figures can be complex. In view of the detailed description provided herein, the skilled artisan will understand how to design and make play treats consistent with those disclosed and claimed herein. Without being limited to any particular curves or shapes and such radii can cover a broad range of curves consistent herewith. In various embodiments, the play treats comprise radii that range from about 0.06 to about 1.50 inch. Preferably the radii range from about 0.1 to about 1.2 inch.

The body is elongate along at least one axis in some embodiments. In other embodiments, the body of the play treat has substantially similar dimensions in all directions in the plane of the surface upon which the play treat rests. In some embodiments, the treat may be substantially symmetrical when viewed from above as the play treat is resting on its unstable surface. The play treat may generally be of any useful size or shape that is adapted for contact-responsiveness as described above. In various embodiments, the play treats have a maximum dimension that is less than about 2.5″ in length or width. Other embodiments feature play treats with a maximum dimension along any one side or one axis that is 2.4, 2.3, 2.2, 2.1, 2.0, 1.9, 1.8, 1.7, 1.6, 1.5, 1.4, 1.3, 1.2, 1.1, 1.0, 0.9, 0.875, 0.8, 0.75, 0.7, 0.67, 0.6, 0.5, or even 0.4 or 0.33 inches. More preferably, the play treat has a maximum dimension along any one side or axis of about 1.5 inches to about 0.5 inches. Still more preferred are play treats with dimensions between about 1.2 inches to about 0.75 inches. The size of the play treats may be at least in part selected based on the size of the animal that it is intended for. Play treat designed for young animals (such as puppies or kittens) may be smaller than those designed for adult animals or the same species. Similarly smaller treats may be better suited to smaller breeds within a species. In certain embodiments, the play treat may be rounded, disc-shaped, or triangular, square, rectangular, or may have 5, 6, 7, 8 or more sides. In one embodiment, the sides of the play treat may be about the same length.

In one embodiment the comestible play treat further comprises at least one substantially convex interior surface opposite the substantially concave outer surface. The convex interior surface preferably at least partially defines an interior space of the play treat.

In one embodiment the comestible play treat comprises at least an inner and outer layer which are coextruded. In various embodiments the inner and outer layers have different nutritional compositions, different colors, different flavors, or different textures, or the like. Preferably if one layer is denser than the other, the denser layer is extruded as the outer layer to help keep the center of gravity lower in the play treat.

The companion animal is a preferably a feline, a canine, or a mustelidine species (e.g., a ferret). Most preferably the companion animal is a feline. In one embodiment the play treat are made as much larger item and are used for non-companion animals such as zoo or circus animals, e.g., bears, and primates, as well as lions, tigers, leopards and the like to enrich their environments, their play and/or diets.

In a second aspect, the disclosure provides comestible play treats for a companion animal comprising a body having a crescentiform cross-section along at least one axis. A radius along at least one additional axis helps to form (preferably along with the crescentiform cross-section) a hull which gives the body a tendency to move when the body is contacted by a companion animal. The movement comprises one or more of wobbling, rocking, spinning, partially rolling, or a combination thereof.

Preferably the body has sufficient width, relative to its length, to decrease the ability of the play treat to rest on a surface other than the hull or a portion of the hull, thereby maintaining the tendency of the body to move responsive to contact by an animal. The hull further has at least one additional radius along its length in various embodiments.

In various embodiments the play treat comprises one or more of (a) an elongate body, (b) a shape, weight, and center of gravity of the play treat adapted to help maintain the orientation of the play treat to preserve a tendency for the body to move when contacted by a companion animal, or (c) at least an inner and outer layer of differing compositions that are co-extruded to form the body.

As with the prior aspect, the animal can be any animal, but preferred are canine, feline, or mustelidine animals in certain embodiments. More preferably the animal is a feline, such as a domestic cat.

In a third aspect, the disclosure provides methods of inducing play in a companion animal. The methods generally comprise the steps of:

providing a comestible play treat having a tendency to move in response to contact by a companion animal;

presenting the comestible play treat to the animal; and

allowing or encouraging the animal to contact the comestible play treat and trigger movement;

thereby inducing the companion animal to play with the play treat;

wherein the movement comprises rocking, spinning, or a combination thereof.

The method can further comprising the step of allowing the animal to consume the treat during or after play. The caloric intake and intake of macro- and micro-nutrients can be taken into consideration in planning for the nutritional needs of the animal. Preferably play treats of different shapes, sizes, flavors, and textures can be used to provide a variety both in play and in diet for the animal. As can be seen in the Examples, after multiple exposures to the same play treats, the frequency of play may decrease. Animals may get accustomed to, desensitized to, or bored with the same play treats repeatedly. Varying the properties of the play treats, such as shape, size, flavor, and/or texture of the treats, is expected to overcome this.

The methods are particularly useful with companion animals such as canine, feline, and mustelidine animals. Preferred embodiments of the methods are well-suited for felines.

The comestible play treats in certain embodiments further comprise a body having a crescentiform cross-section along at least one axis. A radius along at least one additional axis can also be present. Preferably the crescentiform cross-section and radius on the additional axis are oriented to form a base or hull comprising an unstable or wobbly surface portion. This base or hull provides the body with the tendency to move, e.g., when the body is contacted by a animal. The movement comprises wobbling, rocking, partially rolling, spinning, or a combination of any of these movements. These movements tend to attract or engage the animal in a manner that stimulates or induces play.

The dimensions and radii of the play treats are preferably consistent with those described above for the first aspect of this disclosure.

In various embodiments the comestible play treat is presented to one animal e.g., cat, while in other embodiments the play treat is presented to multiple animals in a pack or community environment that may supervised by a human.

Play includes any activities of the animal that may correspond to natural playful behavior. Such behaviors are common among young animals such as kittens and/or puppies, but also seen in adult animals and even aging or aged animals. Examples of play include any one or more of (a) batting the treat, (b) carrying the treat in the mouth, (c) swatting the treat, (d) throwing the treat, (e) tossing the treat in the air and manipulating it with the paws, (f) chasing after the treat, (g) retrieving the treat, (h) pushing the treat with the paws or nose, (i) guarding the treat, (j) spinning or rocking the treat, (k) stalking the treat, or (l) pouncing or jumping on the treat. Some play behaviors may be more common among one particular species versus another. Other play activities may be more difficult to assess including generalized excitement, anticipatory playfulness, play fighting or wrestling, and other preludes to healthy play. In pack or group play, play activities can include multi-animal play with the play treats or actively or passively watching other animals play with the treat.

The presenting step can provide ample opportunities for a human and a companion animal to interact. The play treats may be placed on a surface where the contact-responsive movement is maximized, or the play treat may be tossed or thrown for the animal to chase, or the human may initiate spinning, rocking or other movement when presenting the play treat. In other embodiments, the presenting step involves launching the play treat using a treat launcher or treat popper lid, for example as disclosed in commonly-owned, co-pending U.S. Patent Application Nos. 61/675,051 and 61/675,076.

In another of its several aspects, the disclosure provides methods of enhancing the health or well-being of a companion animal. The methods comprise the steps of:

a) providing a supply of comestible play treats adapted for contact-responsive, play-inducing movement;

b) presenting one or more play treats to the animal on a regular basis or extended regular basis;

c) allowing or encouraging the animal to contact the comestible play treat and trigger the play treat to move, thereby inducing the animal to play;

d) allowing the animal to consume the treat during or after play; and

e) repeating steps a) though d) in a frequency or for a length of time effective for enhancing at least one indicia of health or well-being in the animal relative to an animal that does not play with or consume the play treat.

Also disclosed herein are packages comprising comestible play treats useful for inducing play or increasing the health or well-being of an animal, and a label affixed to the package containing a word or words, picture, design, symbol, acronym, slogan, phrase, or other device, or combination thereof, that indicates that the contents of the package contains a play treat suitable for inducing play or increasing the health or well-being of an animal; wherein the play treats are adapted for contact-responsive, play-inducing movement.

A further aspect of the invention provides methods for helping an animal maintain a desirable body weight, such as an ideal body weight based, for example, on the breed and age of the animal. The methods comprise presenting, on a regular basis, a comestible play treat to the animal and allowing the animal to play with and consume the play treat, thereby helping the animal to maintain a desirable body weight or an ideal body weight; wherein the play treats are adapted for contact-responsive, play-inducing movement.

As the skilled artisan will appreciate, playing with and/or consuming the comestible play treat provides exercise that helps the animal maintain an ideal weight, and also enhances cardiovascular and muscular health. Such activities can also increase reduce stress and/or boredom, thereby improving the animal's mental health. It is also a fun activity to participate in with the animals' human companion, thereby increasing the connection and feelings of belonging.

Another aspect of the invention provides methods for improving the quality of life of an animal. The methods comprise presenting, on a regular basis, a comestible play treat to the animal and allowing the animal to play with and consume the play treat, thereby improving the quality of life of the animal; wherein the play treats are adapted for contact-responsive, play-inducing movement.

As above, playing with and/or consuming the comestible play treat increases the animal's mental health, reduces stress and/or boredom, helps the animal maintain an ideal weight, and enhances cardiovascular and muscular health.

### EXAMPLES

The invention can be further illustrated by the following examples, although it will be understood that these examples are included merely for purposes of illustration and are not intended to limit the scope of the invention unless otherwise specifically indicated.

### Example 1

The dry ingredients shown in Table 1(a) were added to a blender in the amounts shown. This mixture was then ground through a 4/64″ hammer mill screen to reduce the particle size to less than 1600 microns. The blended dry mixture was fed to an extruder at a rate of 10 lbs per minute. At the same time, water was injected into the extruder at 12% of the dry mixture rate and glycerin was injected into the extruder as a plasticizer in at 16% of the dry mixture rate as shown in Table 1(b). The extruder was run at 130 to 150 rpm. The pressure at the discharge head of the extruder was 40-60 bars with an internal product temperature of 180-220° F. as measured in the transition plate between the extruder and die plate. The extruded material was forced through a crescent shaped die opening that creates a comestible play treat for felines with geometry of multiple radii. The pieces were conveyed to a cooler/dryer where their moisture was reduced to 12.5%. The comestible play treat for felines, shown in FIG. 1, had the following dimensions:

| | |
|---|---|
| Length (inches) | 0.23-0.25 |
| Width (inches) | 0.40-0.42 |
| Thickness (inches) | 0.10-0.15 |
| Length radius (inch) | 0.34-0.63 |
| Width radius (inch) | --n/a-- |

TABLE 1(a)

| Ingredients | Weight LBS | % Formula |
|---|---|---|
| Cereal grain flour | 820.15 | 82.015 |
| Meat hydrolysate | 73.87 | 7.387 |
| Yeast | 30.81 | 3.081 |
| Distilled monoglyceride | 17.46 | 1.746 |
| Maltoferm | 14.56 | 1.456 |
| Corn Germ Meal | 12.0 | 1.2 |
| Flavor Blend | 20.56 | 2.056 |
| Color Blend | 6.48 | 0.648 |
| Sorbic Acid | 3.37 | 0.337 |
| Antioxidant Blend | 0.74 | 0.074 |
| Total | 1000 | 100 |

TABLE 1 (b)

| | Weight LBS | % Formula |
|---|---|---|
| Dry Mix | 1000 | 78.125 |
| Water | 120 | 9.375 |
| Glycerin | 160 | 12.5 |
| Total | 1280 | 100 |

### Example 2

The procedure in Example 1 was repeated except that the pieces were cut longer. The comestible play treat for felines, shown in FIG. 2, had the following dimensions:

| | |
|---|---|
| Length (inches) | 1.5-2.0 |
| Width (inches) | 0.37-0.40 |
| Thickness (inches) | 0.12-0.20 |
| Length radius (inch) | 0.21-0.87 |
| Width radius (inch) | 0.56-0.58 |

### Example 3

The procedure in Example 1 was repeated using a dies with asymmetric taper and the taper angle being wider than for dies of Example 1. The comestible play treat for felines, shown in FIG. 3, had the following dimensions:

| | |
|---|---|
| Length (inches) | 0.60-0.75 |
| Width (inches) | 0.76-0.85 |
| Thickness (inches) | 0.12-.20 |
| Length A radius (inch) | 0.15-0.24 |
| Length B radius (inch) | 0.57-0.62 |
| Width radius (inch) | 0.50-0.54 |

### Example 4

The procedure in Example 1 was repeated using dies with taper angle being wider than for dies of Example 1. The comestible play treat for felines, shown in FIG. 4, had the following dimensions:

| | |
|---|---|
| Length (inches) | 0.60-0.75 |
| Width (inches) | 0.70-0.85 |
| Thickness (inches) | 0.12-0.20 |
| Length radius (inch) | 0.09-0.50 |
| Width radius (inch) | 0.56-0.58 |

### Example 5

The procedure in Example 4 was repeated except that each die was rotated 180° thereby changing the location at which cutting of the pieces was initiated. The comestible play treat for felines, shown in FIG. 5, had the following dimensions:

| | |
|---|---|
| Length (inches) | 1.1-1.3 |
| Width (inches) | 0.70-0.85 |
| Thickness (inches) | 0.12-0.20 |
| Length radius (inch) | 0.52-1.02 |
| Width radius (inch) | 0.76-1.09 |

### Example 6

The procedure in Example 1 was repeated except that the comestible play treat of Example 1 contained a second layer of cooked dough made from the ingredients in proportions shown in Table 2(a). The ingredients were combined in a cooker-mixer and the mixture was cooked by heating to 185° F. with continuous mixing. The cooked dough was then pumped by a high-pressure pump into the die assembly where it was co-extruded, along with the extruded material as per Example 1, through a die that was designed to allow the layering of the cooked dough onto the interior side of the extruded shell material (see FIG. 6). As the product exited the extruder dies, a rotating knife cut the product into 1.0 to 1.2 inch length pieces. A conveyor system conveyed the pieces to a cooler. The comestible play treat for felines, shown in FIG. 6, had the following dimensions:

| | |
|---|---|
| Length (inches) | 1.0-1.2 |
| Width (inches) | 0.76-0.85 |
| Thickness (inches) | 0.12-0.20 |
| Length radius (inch) | 0.24-0.54 |
| Width radius (inch) | 0.543-0.54 |

TABLE 2 (a)

| Ingredients | Weight LBS | % Formula |
|---|---|---|
| Gelatin 250 bloom | 14.60 | 1.460 |
| Lecithin | 0.91 | .091 |
| Sugar | 128.19 | 12.819 |
| Wheat Gluten | 23.71 | 2.371 |
| Animal meal | 102.2 | 10.22 |
| Wheat Flour | 322.15 | 32.215 |
| Salt | 17.03 | 1.703 |
| Sorbic Acid | 3.70 | 0.370 |
| Meat hydrolysate | 68.12 | 6.812 |
| Glycerin | 51.76 | 5.176 |
| Hydrogenated corn syrup | 91.1 | 9.11 |
| Water | 89.84 | 8.984 |
| Phosphoric acid | 22.66 | 2.266 |
| Grilled beef flavor | 2.65 | 0.265 |
| Red #40 | 0.38 | 0.038 |
| Beef Tallow | 61.0 | 6.10 |
| Total | 1000 | 100 |

TABLE 2 (b)

| Ingredients | Weight LBS | % Formula |
|---|---|---|
| Extrusion step | 970 | 97.00 |
| Cooked Dough | 30 | 3.00 |
| Total | 1000 | 100 |

### Example 7

The procedure in Example 1 was repeated except that the dies used had S-shaped openings. The comestible play treat for felines, shown in FIG. 7, had the following dimensions:

| | |
|---|---|
| Length (inches) | 0.78-1.2 |
| Width (inches) | 0.55-0.58 |
| Thickness (inches) | 0.08-0.16 |
| Multiple radii (inch) | 0.08, 0.18, 0.31, 0.43, 0.56 |

### Example 8

Five (5) different shapes and sizes of products from Examples 1-5 (FIGS. 1 though 5) of the comestible play treat, as described in Table 3, were tested along with a commercial cat treat in a cattery. Each treat was tested in two rooms of twenty (20) cats each. Twenty (20) pieces of each treat were offered (treats placed on the floor) to each room of cats. Cats were fed with standard food in the morning and then tested in the afternoon. Cats were observed for incidence of play. At least one or more of the following behaviors was exhibited and was defined as play:
Batting the treat with one or both front paws
Picking up treat in mouth and carrying off
Swatting or throwing the treat with one of the front paws
Repeatedly tossing the treat in the air and manipulating it with their paws
Chasing after the treat
Retrieving the treat
Watching other cats play with the treat
Pouncing or jumping on the treat
Guarding the treat
Pushing the treat with the nose
Spinning the treat
Multi-cat play with the treat

The results are shown in Table 3.

TABLE 3

| | Number of |
|---|---|
| | Cats that |
| Comestible Play Treat | Played |
| Highly palatable commercial cat treat (small pillow | 0 |
| shaped kibbles) | |
| A thin cut curl shape with a similar size as the competitive | 0 |
| commercial treat of 0.25″ by 0.25″ (Example 1, and | |
| FIG. 1). | |
| A significant curl shape with 2 radii that promote | 3 |
| movement when batted by cats approximately 2″ by | |
| 0.375″ | |
| (Example 2, and FIG. 2). | |
| A significant curl shape with 2 radii that promote | 7 |
| movement when batted by cats approximately 0.75″ by | |
| 0.75″ (Example 3, and FIG. 3). | |
| A significant curl shape with 2 radii that promote | 11 |
| movement when batted by cats approximately 0.75″ by | |
| 0.75″ (Example 4, and FIG. 4). | |
| A shallow curl shape with 2 radii that promote movement | 9 |
| when batted by cats approximately 1.1″ by 0.75″ | |
| (Example 5, and FIG. 5). | |

Referring to Table 3, no stereotypic pattern of play was observed in any of the tests. High variability was observed between individual cats in the type and intensity of play behavior. This study demonstrated that both the size and shape of the treat are necessary for inducing play in cats. The ability for the cats to do one of the following was necessary for play behavior: pick up the treat in their mouths or paws, bat the treat away from them, chase or retrieve treat, throw the treat in the air and retrieve.

### Example 9

The comestible play treat of Example 6 (shown in FIG. 6) was also tested. Sixty-three (63) individually housed cats were fed two (2) pieces of treats in a bowl in the afternoon for two consecutive days. The cats had access to food and water at all times during the study. Observations on cat behavior towards the treat were scored at the time the treat was offered and again three hours later. The criteria for play were the same as Example 8. The results are shown in Table 4.

TABLE 4

| | Number of |
|---|---|
| | Cats that |
| Comestible Play Treat | Played |
| A wide curl shape with 2 radii that promote movement when | 24 |
| batted by cats. It also has a thin layer of different texture | |
| formulation approximately 1.1″ by 0.75″ | |
| (Example 6, and FIG. 6) | |

Referring to Table 4, although the treats were placed in bowls instead of the floor as in Example 8, the cats that were reported to play took the treat out of the bowl to play.

### Example 10

Example 9 was repeated with ten (10) cats and observations for play were made over 4 days. The cats were tested individually in an open room with the technician who executed the test, and with other toys present. A single treat was offered to each cat, each day, and if they did not take the treat from the hand of the technician, it was placed on the floor. The cats were observed for ten (10) minutes and scored as to whether they played with the treat or not. The criteria for play were the same as Example 8. The results are shown in Table 5.

TABLE 5

| | Number of Cats that |
|---|---|
| | Played with Comestible |
| | Play Treat (Example 6, |
| | and shown in FIG. 6) |
| Day 1 | 7 |
| Day 2 | 5 |
| Day 3 | 2 |
| Day 4 | 2 |

Referring to Table 5, although most cats played with the treat/toy on the first day, play was still observed on the last test day.

### Example 11

Example 10 was repeated except that the testing was done in-home instead of a cattery. Fifty-nine (59) cats in fifty-nine (59) different homes were used and observations made over two days. On each of the two days, the cat in each home was offered a fresh treat (Product of Example 6, shown in FIG. 6). Play was determined using the criteria described in Example 8. The results are shown in Table 6.

TABLE 6

| | Day 1 - Number cats | Day 2 - Number cats |
|---|---|---|
| | that played | that played |
| Comestible Play Treat | 33 | 12 |
| (Example 6, and FIG. 6) | | |

Referring to Table 6, as was observed in the cattery environment, more play occurred on the first exposure but cats continued to play when offered the treat a second time.

The results from the Examples show that felines benefit from the comestible play treat as follows:
Exercise—the treat elicits play behaviors from cats. The treat can be used to prevent weight gain or aid in weight loss in cats.
cognitive enrichment—three cats (one from each study) were observed trying to retrieve the treats if it went underneath other objects (e.g., a rug)
Environmental enrichment—allows cats housed indoors to engage in natural play behaviors safely

The specification discloses typical preferred embodiments of the invention. Although specific terms are employed, they are used in a generic and descriptive sense only and not for purposes of limitation. The scope of the invention is set forth in the claims. Many modifications and variations of the invention are possible in light of the above teachings. It is therefore to be understood that within the scope of the appended claims the invention may be practiced otherwise than as specifically described.

What is claimed is:

1. A comestible play treat for companion animals comprising a body having an at least partially arcuate shape having at least one substantially concave outer surface forming a unstable base thereon upon which the play treat may rest; wherein when oriented on its unstable base the play treat is adapted for play-inducing motion in response to contact by a companion animal.

2. The comestible play treat of claim 1 wherein the play-inducing motion includes wobbling, rocking, spinning, or partially rolling of the play treat, or a combination thereof.

3. The comestible play treat of claim 1 wherein the body comprises a plurality of radii oriented in two or more axes.

4. The comestible play treat of claim 2 wherein the radii range from about 0.08 to about 1.2 inch.

5. The comestible play treat of claim 3 wherein the shape, weight, and center of gravity of the play treat are adapted to help maintain the orientation of the play treat on its unstable base so as to facilitate play-inducing motion in response to contact by a companion animal.

6. The comestible play treat of claim 4 wherein the body has a width relative to length that helps maintain the orientation of the play treat on its unstable base.

7. The comestible play treat of claim 5 wherein the shorter of the body's length or width is at least about 0.3 inches to about 1.2 inches.

8. The comestible play treat of claim 5 wherein the body's length and width are about the same.

9. The comestible play treat of claim 7 wherein the body's length and width are each about 0.3 inches to 1.2 inches.

10. The comestible play treat of claim 4 wherein the body's width and length are less than about 2.5 inches.

11. The comestible play treat of claim 4 wherein the body has a thickness that is about 0.05 to about 0.3 inches.

12. The comestible play treat of claim 10 wherein the thickness is substantially uniform along the body's width, length or both.

13. The comestible play treat of claim 1 wherein, along at least one axis, the body has a cross-sectional profile that is crescentiform.

14. The comestible play treat of claim 1 wherein the body is elongate along at least one axis.

15. The comestible play treat of claim 1 further comprising at least one substantially convex interior surface opposite the unstable base; said convex interior surface at least partially defining an interior space of the play treat.

16. The comestible play treat of claim 1 comprising at least an inner and outer layer which are coextruded; wherein the inner and outer layers have one or more of different nutritional compositions, different colors, different flavors, or different textures.

17. The comestible play treat of claim 1 wherein the companion animal is a feline.

18. A comestible play treat for a companion animal comprising a body having a crescentiform cross-section along at least one axis, and a radius along at least one additional axis; said crescentiform cross-section and radius forming a hull giving the body a tendency to move when the body is contacted by a companion animal said movement comprising rocking, spinning, or a combination thereof.

19. The comestible play treat of claim 18 wherein the body has sufficient width, relative to its length, to decrease the ability of the play treat to rest on a surface other than the hull, thereby maintaining the tendency of the body to move responsive to contact by a companion animal.

20. The comestible play treat of claim 18 wherein the hull has at least one additional radius along its length.

21. The comestible play treat of claim 18 further comprising one or more of (a) an elongate body, (b) a shape, weight, and center of gravity of the play treat adapted to help maintain the orientation of the play treat to preserve tendency for the body to move when contacted by a companion animal, or (c) at least an inner and outer layer of differing compositions that are co-extruded to form the body.

22. The comestible play treat of claim 21 wherein the companion animal is a feline.

23. The comestible play treat of claim 18 wherein the body has a width relative to length that helps maintain the orientation of the play treat on its hull.

24. The comestible play treat of claim 23 wherein the shorter of the body's length or width is at least about 0.3 inches to about 1.2 inches.

25. The comestible play treat of claim 23 wherein the body's length and width are about the same.

26. The comestible play treat of claim 25 wherein the body's length and width are each about 0.3 inches to 1.2 inches.

27. The comestible play treat of claim 23 wherein the body's width and length are less than about 2.5 inches.

28. The comestible play treat of claim 18 wherein the body has a thickness that is about 0.05 to about 0.3 inches.

29. The comestible play treat of claim 28 wherein the thickness is substantially uniform along the body's width, length or both.

30. A method of inducing play in a companion animal comprising:
providing a comestible play treat having a tendency to move in response to contact by a companion animal;
presenting the comestible play treat to the animal; and
allowing or encouraging the animal to contact the comestible play treat and trigger movement;
thereby inducing the companion animal to play with the play treat;
wherein the movement comprises rocking, spinning, or a combination thereof.

31. The method of claim 30 comprising the further step of allowing the animal to consume the treat during or after play.

32. The method of claim 30 wherein the companion animal is a feline.

33. The method of claim 30 wherein the comestible play treat further comprises a body having a crescentiform cross-section along at least one axis, and a radius along at least one additional axis; said crescentiform cross-section and radius oriented so as to form an unstable base giving the body a tendency to move when the body is contacted by a companion animal said movement comprising rocking, spinning, or a combination thereof.
